(19) United States
(12) Patent Application Publication
(10) Pub. No.: US 2026/0181484 A1
(43) Pub. Date: Jun. 25, 2026

(54) VOICE CALL HANDOVER BASED ON VOICE OVER WI-FI TO EVOLVED PACKET SYSTEM-FALLBACK HANDOVER INDICATOR

(71) Applicant: T-MOBILE INNOVATIONS LLC, Overland Park, KS (US)

(72) Inventor: Lin ZHANG, Overland Park, KS (US)

(21) Appl. No.: 19/001,080

(22) Filed: Dec. 24, 2024

(51) Int. Cl. H04W 36/00

(52) U.S. Cl. CPC H04W 36/00222

(57) ABSTRACT

Systems and methods for voice call handovers are provided. A user device, while on a VoWiFi call, sends a first request to a base station to handover the VoWiFi call to VoNR on a particular cell. In response to a determination that the base station does not support VoNR on the particular cell, the base station sends a message to the user device including an indicator instructing the user device to perform a VoWiFi to EPS-FB handover. In response to the message with the indicator instructing the user device to perform a VoWiFi to EPS-FB handover, the user device implements operations of a VoWiFi to EPS-FB handover resulting in a handover of the VoWiFi call to VoLTE on an LTE cell.

### SUMMARY

The present disclosure is directed, in part, to voice call handovers substantially as shown in and/or described in connection with at least one of the figures, and as set forth more completely in the claims.

A high-level overview of various aspects of the present technology is provided in this section to introduce a selection of concepts in a simplified form that are further described below in the detailed description. This summary is not intended to identify key features or essential features of the claimed subject matter, nor is it intended to be used in isolation as an aid in determining the scope of the claimed subject matter.

In aspects set forth herein, and at a high level, the technology described herein relates to facilitating a voice call handover from Voice over Wi-Fi (VoWiFi) to cellular based, at least in part, on providing more explicit instructions to a user device for implementing a handover from VoWiFi to cellular. User devices are typically unaware of whether a base station supports VoNR on particular cells, and these user devices may send a request to a base station to handover a VoWiFi call to VoNR when the base station does not support VoNR, which often leads to dropped calls. Aspects herein provide for base stations that do not support VoNR on a particular cell to send messages to user devices with an indicator instructing the user devices to perform a VoWiFi to Evolved Packet System Fallback (EPS-FB) handover. The techniques described herein provide more explicit instructions to user devices to ensure a proper call flow is performed and may significantly reduce the number of dropped calls experienced when requesting a handover from VoWiFi to cellular.

### BRIEF DESCRIPTION OF THE DRAWINGS

Aspects of the present disclosure are described in detail herein with reference to the attached Figures, which are intended to be exemplary and non-limiting, wherein:

FIG. 1 is a diagram illustrating an example computing device, in accordance with aspects herein;

FIG. 2 is a diagram illustrating an example network environment for use in accordance with aspects herein;

FIG. 3 is flow chart illustrating an example method for handover management, in accordance with aspects herein; and

FIG. 4 is flow chart illustrating an example method for handover management, in accordance with aspects herein; and

FIG. 5 is a flow chart illustrating an example method for implementing operations of a VoWiFi to EPS-FB handover, in accordance with aspects herein.

### DETAILED DESCRIPTION

The subject matter of embodiments of the present disclosure is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

By way of background, a voice call for a user device may be implemented over Wi-Fi (e.g., using VoWiFi) or cellular (e.g., using Voice over New Radio (VoNR) or Voice over LTE (VoLTE)). Mobile network operators (MNOs) are in the process of deploying 5G service across their networks, but there are still coverage areas where 5G service may not be available or where some 5G services (e.g., VoNR) may not be supported on at least some cells of a base station (e.g., 5G gNodeB (gNB)). When a voice call is initiated on cellular for a user device that supports VoNR and the user device is connected to a 5G NR cell, the base station will initiate the call using VoNR if the base station supports it. However, if the base station does not support VoNR on the 5G NR cell, the base station will initiate an Evolved Packet System Fallback (EPS-FB) and the voice call will be implemented using VoLTE. Situations may arise where a user device requests a handover of a voice call from VoWiFi to VoNR (e.g., when the user device moves from indoors to outdoors), but the base station may or may not support VoNR on the serving cell for the user device. If the base station does not support VoNR on the serving cell for the user device, MNOs may implement different call flows for handling this situation because 3GPP doesn’t have a mandatory and precise enough call flow defined. The user device may not use, or be aware of, the proper call flow implemented by the MNO, which can lead to poor user experience.

Conventionally, when a user device is on a VoWiFi call and the user device supports VoNR, the user device sends a request for a handover from VoWiFi to VoNR when it is connected to a 5G NR cell. If the base station or the serving cell does not support VoNR, the base station may initiate an EPS-FB procedure by sending an RRC release message with redirection to LTE (may include list of LTE bands) to the user device. Many user devices are not able to handle this situation and drop the call for various reasons. If the EPS-FB procedure is successfully completed, many user devices will not repeat the handover decision process or submit the handover request again over LTE, which eventually results in a dropped call. Some user devices may send a Packet Data Network (PDN) Connectivity Request after a successful EPS-FB procedure, but many of these user devices include an “initial request” indicator in the PDN Connectivity Request, which results in an IP address change and a dropped call. Accordingly, many user devices experience a high level of dropped calls after requesting a handover from VoWiFi to VoNR.

Unlike conventional solutions, the present disclosure is directed to increasing the specificity of instructions to user devices that may need to handover a voice call from VoWiFi to cellular. The user device, while on a VoWiFi call, may send a request to a base station to handover the VoWiFi call to VoNR on a particular cell. It may be determined whether the base station supports VoNR on the particular cell or not. In response to a determination that the base station does not support VoNR on the particular cell, the base station may send a message (e.g., Radio Resource Control (RRC) Release with redirection to Long Term Evolution (LTE)) to the user device with an indicator instructing the user device to perform a VoWiFi to Evolved Packet System-Fallback (EPS-FB) handover. In response to the message with the indicator instructing the user device to perform the VoWiFi to EPS-FB handover, the user device may implement operations of a VoWiFi to EPS-FB handover resulting in a handover of the VoWiFi call to Voice over Long Term Evolution (VoLTE) on an LTE cell. The LTE cell may be a second cell of the first base station or a cell of a second base station that is different than the first base station. The operations may include performing an EPS-FB procedure and camping on the LTE cell. After performing the EPS-FB procedure, the user device may then send a second request to handover the VoWiFi call to VoLTE (e.g., a PDN Connectivity Request with a handover request type) on the LTE cell. The request to handover the VoWiFi call to VoLTE may be based, at least in part, of measured signal strengths of Wi-Fi signals and/or LTE signals.

By increasing the specificity of the instructions to the user device in the message sent in response to the request to handover the VoWiFi call to VoNR, the user device may avoid some of the pitfalls for the call flow described above that leads to dropped calls for a majority of user devices after requesting a handover of the VoWiFi call to VoNR. Accordingly, the complexity of the VoWiFi to cellular handover procedure may be reduced for user devices that utilize the techniques described herein compared to current techniques and lead to better service quality and reduced instances of dropped calls.

In one aspect, a method is provided for handover management. The method is performed while on a Voice over Wi-Fi (VoWiFi) call. The method includes sending a first request to a first base station. The first request includes a request to handover the VoWiFi call to Voice over New Radio (VoNR) on a first cell of the first base station. The method also includes receiving, from the first base station, a message with an indicator that instructs a user device to perform a VoWiFi to Evolved Packet System-Fallback (EPS-FB) handover. Further, the method includes, in response to the message with the indicator that instructs the user device to perform the VoWiFi to EPS-FB handover, implementing operations of a VoWiFi to EPS-FB handover resulting in a handover of the VoWiFi call to Voice over Long Term Evolution (VoLTE) on an LTE cell.

In another aspect, a base station is provided. The base station includes one or more processors and one or more computer-readable media storing computer-usable instructions that, when executed by the one or more processors, cause the one or more processors to perform a method. The method includes receiving a request from a user device to handover a Voice over Wi-Fi (VoWiFi) call to Voice over New Radio (VoNR) on a first cell. The method also includes determining whether the base station supports VoNR on the first cell. Further, the method includes, in response to a determination that the base station does not support VoNR on the first cell, sending a message to the user device comprising an indicator instructing the user device to perform a VoWiFi to Evolved Packet System-Fallback (EPS-FB) handover.

In yet another aspect, a user device is provided. The user device includes one or more processors and one or more computer-readable media storing computer-usable instructions that, when executed by the one or more processors, cause the one or more processors to perform a method. The method is performed while on a Voice over Wi-Fi (VoWiFi) call. The method includes sending a first request to a first base station to handover the VoWiFi call to Voice over New Radio (VoNR) on a first cell of the first base station. The method also includes receiving a message including an indicator that instructs the user device to perform a VoWiFi to Evolved Packet System-Fallback (EPS-FB) handover. Further, the method includes, in response to the message including the indicator that instructs the user device to perform a VoWiFi to EPS-FB handover, implementing a VoWiFi to EPS-FB handover using a plurality of operations.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunications arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

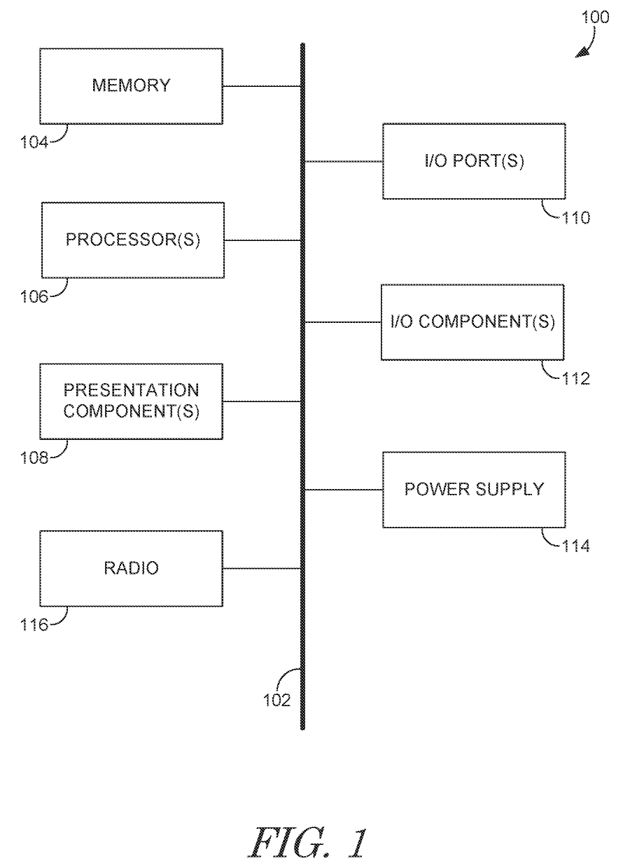

Referring to the drawings in general, and initially to FIG. 1, an exemplary computing device 100 suitable for practicing embodiments of the present technology is provided. The computing device 100 is just one example, and is not intended to suggest any limitation as to the scope of use or functionality of the embodiments discussed herein. Furthermore, the computing device 100 should not be interpreted as having any dependency or requirement relating to any one or a combination of components illustrated. It should be noted that although some components in FIG. 1 are shown in the singular, they may be plural. For example, the computing device 100 might include multiple processors and/or multiple radios. As shown in FIG. 1, computing device 100 includes a bus 102 that directly or indirectly couples various components together, including a memory 104, processor(s) 106, presentation component(s) 108 (if applicable), radio(s) 116, input/output (I/O) port(s) 110, I/O component(s) 112, and a power supply 114. More or fewer components are possible and contemplated, including in consolidated or distributed form.

The memory 104 may take the form of memory components described herein. Thus, further elaboration will not be provided here, but it should be noted that the memory 104 may include any type of tangible medium that is capable of storing information, such as a database. A database may be any collection of records, data, and/or information. In one embodiment, memory 104 may include a set of embodied computer-executable instructions that, when executed, facilitate various functions or elements disclosed herein. These embodied instructions will variously be referred to as “instructions” or an “application” for short. The processor 106 may actually be multiple processors that receive instructions and process them accordingly. The presentation component 108 may include a display, a speaker, and/or other components that may present information (e.g., a display, a screen, a lamp (LED), a graphical user interface (GUI), and/or even lighted keyboards) through visual, auditory, and/or other tactile cues.

The radio 116 may facilitate communication with a network, and may additionally or alternatively facilitate other types of wireless communications, such as Wi-Fi, WiMAX, LTE, 5G, 6G, and/or other VoIP communications. In various embodiments, the radio 116 may be configured to support multiple technologies, and/or multiple radios may be configured and utilized to support multiple technologies. The I/O ports 110 may take a variety of forms. Exemplary I/O ports may include a USB jack, a stereo jack, an infrared port, a firewire port, other proprietary communications ports, and the like. The I/O components 112 may comprise keyboards, microphones, speakers, touchscreens, and/or any other item usable to directly or indirectly input data into the computing device 100. Power supply 114 may include batteries, fuel cells, and/or any other component that may act as a power source to supply power to the computing device 100 or to other network components, including through one or more electrical connections or couplings. Power supply 114 may be configured to selectively supply power to different components independently and/or concurrently.

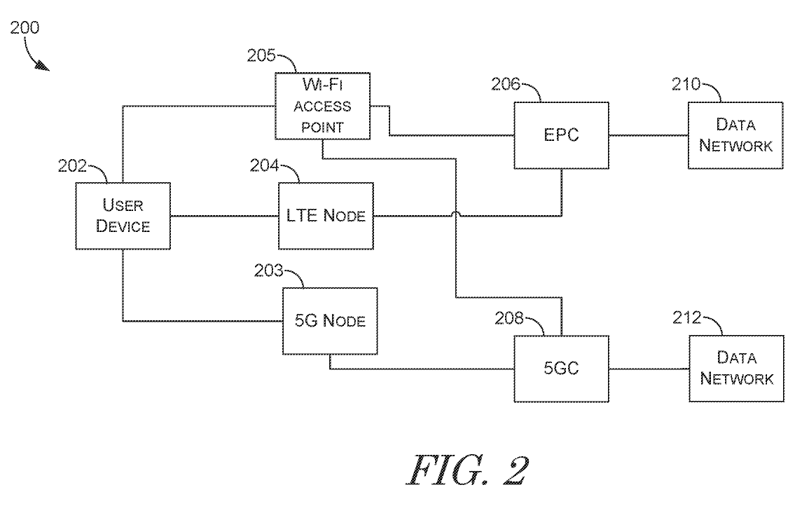

Turning to FIG. 2, FIG. 2 provides an exemplary network environment in which implementations of the present disclosure may be employed. Such a network environment is illustrated and designated generally as network environment 200. Network environment 200 is but one example of a suitable network environment and is not intended to suggest any limitation as to the scope of use or functionality of the embodiments discussed herein. Neither should the network environment be interpreted as having any dependency or requirement relating to any one or combination of components illustrated.

As shown in FIG. 2, the network environment 200 comprises a user device 202, a 5G node 203, an LTE node 204, a Wi-Fi access point 205, an Evolved Packet Core (EPC) 206, a 5G Core (5GC) 208, a first data network 210, and a second data network 212. It should be noted that although some components in FIG. 2 are shown in the singular, they may be plural. For example, the network environment 200 may include multiple 5G nodes 203, multiple LTE nodes 204, and/or multiple Wi-Fi access points 205. More or fewer components are possible and contemplated, including in consolidated or distributed form.

The user device 202 may include any device employed by an end-user to communicate with a telecommunications network, such as a wireless telecommunications network. The user device 202 may, in general, comprise forms of equipment and machines such as but, not limited to, Internet-of-Things (IoT) devices and smart appliances, autonomous or semi-autonomous vehicles including cars, trucks, trains, aircraft, urban air mobility (UAM) vehicles and/or drones, industrial machinery, robotic devices, exoskeletons, manufacturing tooling, thermostats, locks, smart speakers, lighting devices, smart receptacles, controllers, mechanical actuators, remote sensors, weather or other environmental sensors, wireless beacons, cash registers, turnstiles, security gates, or any other smart device. That said, in some embodiments, the user device 202 may include computing devices such as, but not limited to, handheld personal computing devices, cellular phones, smartphones, tablets, laptops, and similar consumer equipment, or stationary desktop computing devices, workstations, servers and/or network infrastructure equipment. As such, the user device 202 may be a mobile UE or a stationary UE. The user device 202 may include one or more processors, and one or more non-transient computer-readable media for executing code to carry out the functions of the user device 202 described herein. The computer-readable media may include computer-readable instructions executable by the one or more processors. In some embodiments, the user device 202 may be implemented using a computing device 100 as discussed below with respect to FIG. 1.

Nodes, such as the 5G node 203 and LTE node 204, are often individually referred to as a radio access network (RAN) and/or a wireless communication base station system. The 5G node 203 and the LTE node 204 may support or contain one or more cells and each cell utilizes a different frequency band.

In the embodiment shown in FIG. 2, the 5G node 203 may function as an access node via which the user device 202 within coverage area of the 5G node 203 can wirelessly access services of the 5GC 208, such as telecommunications and data connectivity. In the context of 5G NR, the 5G node 203 may be referred to as a 5G base station, a gNodeB, or gNB. In the embodiment shown in FIG. 2, the LTE node 204 may function as an access node via which the user device 202 within coverage area of the LTE node 204 can wirelessly access services of the EPC 206, such as telecommunications and data connectivity. In the context of 4G LTE, the LTE node 204 may be referred to as an LTE base station, an eNodeB, or eNB.

The 5G node 203 and LTE node 204 may be terrestrial or extraterrestrial. Other terminology may also be used depending on the specific implementation technology. As such, in some embodiments, the network environment 200 comprises, at least in part, a wireless communications network, such as the EPC 206 and the 5GC 208. The EPC 206 and the 5GC 208 also communicate with the first data network 210 and the second data network 212, respectively.

In some embodiments, the 5G node 203 and/or LTE node 204 may comprise a multi-modal network (e.g., comprising one or more multi-modal access devices) where multiple radios supporting different systems are integrated into the radio of the 5G node 203 and/or the LTE node 204. Such a multi-modal RAN may support a combination of 3GPP radio technologies (e.g., 4G, 5G and/or 6G) and/or non-3GPP radio technologies.

The EPC 206 may be a component of a wireless communications network that provides one or more wireless network services to one or more devices (e.g., user device 202) within the coverage areas of a plurality of nodes, including the LTE node 204. In particular, the EPC 206 provides combinations of network services to the user device 202 for one or more LTE cells that the user device 202 may attach to via channels of one or more RF bands (referred to herein as RF band layers).

The 5GC 208 may be a component of a wireless communications network that provides one or more wireless network services to one or more devices (e.g., user device 202) within the coverage areas of a plurality of nodes, including the 5G node 203. In particular, the 5GC 208 provides combinations of network services to the user device 202 for one or more 5G NR cells that the user device 202 may attach to via RF band layers.

The Wi-Fi access point 205 may function as an access node via which the user device 202 within the coverage area of the Wi-Fi access point 205 can wirelessly access a local area networks (LANs) and/or wide area networks (WANs), including the Internet. In the context of the present disclosure, the Wi-Fi access point 205 provides a wireless connection for VoWiFi service provided to the user device 202.

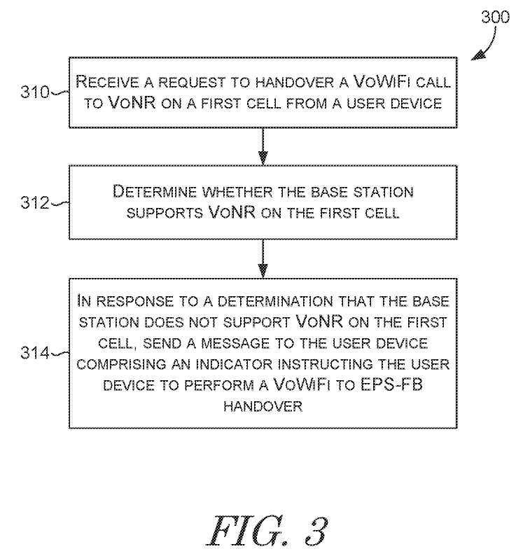

Turning now to FIG. 3, a method 300 is provided for handover management, in accordance with some embodiments of the present disclosure. It should be understood that the features and elements described herein with respect to the method 300 of FIG. 3 may be used in conjunction with, in combination with, or substituted for elements of, any of the other embodiments discussed herein and vice versa. Further, it should be understood that the functions, structures, and other descriptions of elements for embodiments described in FIG. 3 may apply to like or similarly named or described elements across any of the figures and/or embodiments described herein and vice versa. The method 300 may be performed by a base station (e.g., the 5G node 203 described above with respect to FIG. 2).

At block 310, a request to handover a VoWiFi call to VoNR on a first cell is received from a user device. The user device may be connected to the first cell (e.g., for a data connection) and the first cell may be a 5G NR cell. In some embodiments, the request to handover the VoWiFi call to VoNR on the first cell may include a PDU Session Establishment Request with the Request Type set to “Existing PDU Session.”

At block 312, it is determined whether the base station supports VoNR on the first cell. The base station may support VoNR on a subset of cells with which the base station provides services to user devices. The base station may determine whether the base station supports VoNR on the first cell based on whether an indicator in a table or other data structure indicates whether the base station as a whole supports VoNR or whether the base station supports VoNR on particular cells. The table or other data structure may be in a computer-storage media of the base station itself or another component of the telecommunications network.

At block 314, in response to determining that the base station does not support VoNR on the first cell, a message is sent to the user device with an indicator instructing the user device to perform a VoWiFi to EPS-FB handover. A VoWiFi to EPS-FB handover may include an EPS-FB procedure to an LTE cell and result in a handover of the VoWiFi call to VoLTE rather than VoNR as intended by the user device when sending the initial request.

In some embodiments, the message sent to the user device with the indicator instructing the user device to perform a VoWiFi to EPS-FB handover may be a Radio Resource Control (RRC) Release message with redirection to LTE. The RRC Release message may include an Information Element (IE) indicating redirection to Evolved Universal Terrestrial Radio Access (E-UTRA) and may include one or more target carrier frequencies for an LTE cell.

In some embodiments, the indicator instructing the user device to perform a VoWiFi to EPS-FB handover may be an IE contained in RRC Release message transmitted by the base station. The IE may provide more context to the user device that the purpose of the RRC Release message being sent in response to the request to handover the VoWiFi call to VoNR is to trigger the user device to perform a VoWiFi to EPS-FB handover. In a non-limiting example, the IE (e.g., voWiFi2EPSFallbackInd) may be added in the RRC Release message and may be implemented, for example, using Boolean logic (e.g., using 1/0 or true/false) to indicate whether the user device is to perform a VoWiFi to EPS-FB handover or not. The IE may not be added in the RRC Release message when the user device does not need to perform a VoWiFi to EPS-FB handover (e.g., as part of a different call flow).

In some embodiments, the base station may support VoNR on a second cell even if the base station does not support VoNR on the first cell. If the base station receives a second request from a second user device to handover a second VoWiFi call to VoNR on the second cell, the base station may determine that the base station supports VoNR on the second cell based on an indicator in a table or other data structure indicating that the base station supports VoNR on particular cells. In response to a determination that the base station does support VoNR on the second cell, the base station may implement a VoWiFi to VoNR handover for the second VoWiFi call on the second cell. The call flow used for the handover of the second VoWiFi call to VoNR on the second cell may follow the standardized procedure for handing over a VoWiFi call to VoNR as provided by 3GPP with the user device being attached to the second cell that supports VoNR.

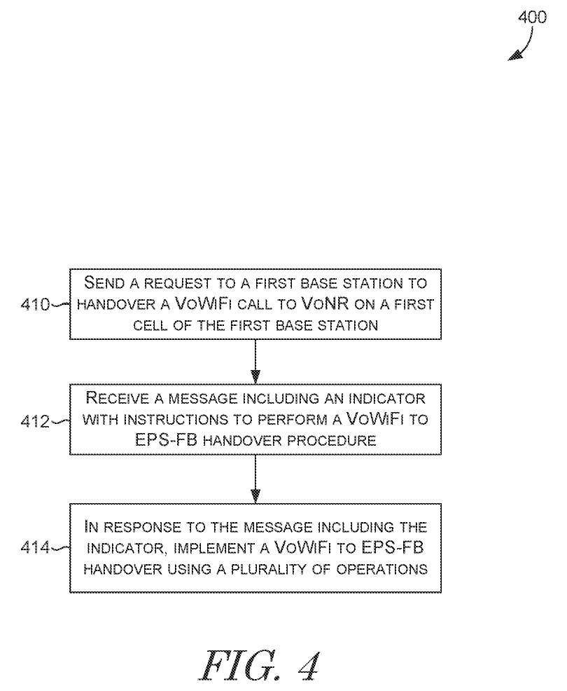

Referring now to FIG. 4, a method 400 is provided for handover management, in accordance with some embodiments of the present disclosure. It should be understood that the features and elements described herein with respect to the method 400 of FIG. 4 may be used in conjunction with, in combination with, or substituted for elements of, any of the other embodiments discussed herein and vice versa. Further, it should be understood that the functions, structures, and other descriptions of elements for embodiments described in FIG. 4 may apply to like or similarly named or described elements across any of the figures and/or embodiments described herein and vice versa. The method 400 may be performed by a user device (e.g., computing device 100 or user device 202 described above with respect to FIGS. 1-2) while on a VoWiFi call.

At block 410, a request is sent to a first base station to handover the VoWiFi call to VoNR on a first cell of the first base station. The user device may be connected to the first cell (e.g., for a data connection), the first base station may comprise a 5G base station (e.g., 5G node 203), and the first cell may be a5G NR cell. In some embodiments, the request to handover the VoWiFi call to VoNR on the first cell may include a PDU Session Establishment Request with the Request Type set to “Existing PDU Session.”

At block 412, a message including an indicator instructing the user device to perform a VoWiFi to EPS-FB handover is received from the first base station. The message including the indicator instructing the user device to perform a VoWiFi to EPS-FB handover may be a Radio Resource Control (RRC) Release message with redirection to LTE. The RRC Release message may include an IE indicating redirection to Evolved Universal Terrestrial Radio Access (E-UTRA) and may include one or more target carrier frequencies for an LTE cell.

In some embodiments, the user device determines that the message includes the indicator instructing the user device to perform the VoWiFi to EPS-FB handover based on, for example, a status of an IE (e.g., voWiFi2EPSFallbackInd) in RRC Release message received from the first base station. For example, the IE may indicate whether the user device is to perform a VoWiFi to EPS-FB handover or not using Boolean logic (e.g., using 1/0 or true/false). In some embodiments, the IE may only be included in the RRC Release message when the user device is to perform a VoWiFi to EPS-FB handover, so the user device may determine that the VoWiFi to EPS-FB handover is needed based on the presence of the IE in the RRC Release message in these circumstances.

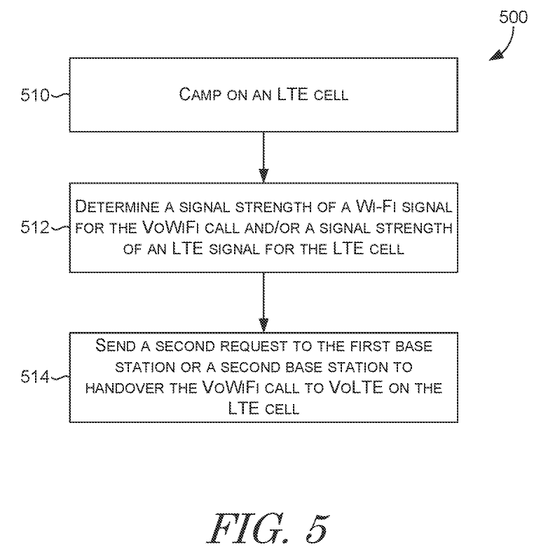

At block 414, in response to the message including the indicator instructing the user device to perform a VoWiFi to EPS-FB handover, the user device implements a VoWiFi to EPS-FB handover using a plurality of operations. A VoWiFi to EPS-FB handover may include an EPS-FB procedure to an LTE cell and result in a handover of the VoWiFi call to VoLTE on an LTE cell (e.g., of the first base station or of a second base station that is different than the first base station) rather than to VoNR on the first cell of the first base station as intended by the user device when sending the initial request at block 410. The operations used to implement the VoWiFi to EPS-FB handover are discussed in further detail with respect to FIG. 5.

Referring now to FIG. 5, a method 500 is provided for implementing operations of a VoWiFi to EPS-FB handover, in accordance with some embodiments of the present disclosure. It should be understood that the features and elements described herein with respect to the method 500 of FIG. 5 may be used in conjunction with, in combination with, or substituted for elements of, any of the other embodiments discussed herein and vice versa. Further, it should be understood that the functions, structures, and other descriptions of elements for embodiments described in FIG. 5 may apply to like or similarly named or described elements across any of the figures and/or embodiments described herein and vice versa. The method 500 may be performed by a user device (e.g., computing device 100 or user device 202 described above with respect to FIGS. 1-2).

At block 510, the user device camps on an LTE cell. The LTE cell may be a second cell of the first base station or may be a cell of a second base station that is different than the first base station (e.g., LTE node 204). The user device may, as part of the EPS-FB procedure for the VoWiFi to EPS-FB handover, search for available LTE cells, select an LTE cell with the highest priority (e.g., based on a predefined priority from the base station) that has an acceptable signal strength, and utilize other existing techniques to perform an EPS-FB procedure and camp on the LTE cell as defined by 3GPP. In some embodiments, the user device searches for the available LTE cells using one or more target carrier frequencies for an LTE cell identified in the message (e.g., the RRC Release message with redirection to LTE) from the base station.

At block 512, the user device may optionally determine a signal strength of a Wi-Fi signal for the VoWiFi call and/or a signal strength of an LTE signal for the LTE cell. The signal strength of the Wi-Fi signal for the VoWiFi call may correspond to a radio frequency signal strength of the Wi-Fi signal for the VoWiFi call, and the signal strength of the LTE signal for the LTE cell may correspond to a radio frequency signal strength of the LTE signal for the LTE cell. In some embodiments, the user device may also compare the signal strength of the Wi-Fi signal for the VoWiFi call to a threshold, compare the signal strength of the LTE signal for the LTE cell to a threshold, and/or compare the signal strength of the Wi-Fi signal for the VoWiFi call to the signal strength of the LTE signal for the LTE cell.

At block 514, the user device sends a second request to the first base station or the second base station to handover the VoWiFi call to VoLTE on the LTE cell. The second request may be sent to the first base station when the LTE cell is a second cell of the first base station. The second request may be sent to the second base station when the LTE cell is a cell of the second base station. In some embodiments, the second request to first base station or the second base station to handover the VoWiFi call to VoLTE on the LTE cell comprises a PDN Connectivity Request with a Request Type set to “Handover.” This request type may help the continuity of the voice call, in part, because the same IP address is retained after handover of the VoWiFi call to VoLTE on the LTE cell.

In some embodiments, the user device may send the second request to the first base station or the second base station to handover the VoWiFi call to VoLTE on the LTE cell based on the signal strength of the Wi-Fi signal for the VoWiFi call and/or the signal strength of the LTE signal for the LTE cell. For example, the user device may send the second request to the first base station or the second base station to handover the VoWiFi call to VoLTE on the LTE cell based on the signal strength of the Wi-Fi signal for the VoWiFi call falling below a threshold (e.g., determined by the user device manufacturer or network operator) and/or based on the signal strength of the LTE signal for the LTE cell exceeding a threshold (e.g., determined by the user device manufacturer or network operator).

The user device may also send the second request to the first base station or the second base station to handover the VoWiFi call to VoLTE on the LTE cell based on a comparison of the signal strength of the Wi-Fi signal for the VoWiFi call and the signal strength of the LTE signal for the LTE cell. For example, the user device may send the second request to the first base station or the second base station to handover the VoWiFi call to VoLTE on the LTE cell in response to determining that the signal strength of the LTE signal for the LTE cell is higher than the signal strength of the Wi-Fi signal for the VoWiFi call. In some embodiments, the signal strength of the LTE signal for the LTE cell needs to exceed the signal strength of the Wi-Fi signal for the VoWiFi call by a threshold amount (e.g., determined by the user device manufacturer or network operator) to trigger the user device to send the second request to the first base station or the second base station to handover the VoWiFi call to VoLTE on the LTE cell.

As used herein, the terms “function”, “unit”, “server”, “node” and “module” are used to describe computer processing components and/or one or more computer executable services being executed on one or more computer processing components. In the context of this disclosure, such terms used in this manner would be understood by one skilled in the art to refer to specific network elements and not used as nonce word or intended to invoke 35 U.S.C. 112(f).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for handover management, comprising:
while on a Voice over Wi-Fi (VoWiFi) call,
sending a first request to a first base station, wherein the first request includes a request to handover the VoWiFi call to Voice over New Radio (VoNR) on a first cell of the first base station;
receiving, from the first base station, a message with an indicator that instructs a user device to perform a VoWiFi to Evolved Packet System-Fallback (EPS-FB) handover; and
in response to the message with the indicator that instructs the user device to perform the VoWiFi to EPS-FB handover, implementing operations of a VoWiFi to EPS-FB handover resulting in a handover of the VoWiFi call to Voice over Long Term Evolution (VoLTE) on an LTE cell.

2. The method of claim 1, wherein the message with the indicator that instructs the user device to perform the VoWiFi to EPS-FB handover comprises a Radio Resource Control (RRC) Release message with redirection to LTE.

3. The method of claim 2, wherein the indicator that instructs the user device to perform the VoWiFi to EPS-FB handover comprises an Information Element in the RRC Release message with redirection to LTE.

4. The method of claim 1, wherein implementing operations of the VoWiFi to EPS-FB handover resulting in the handover of the VoWiFi call to VoLTE on the LTE cell comprises camping on the LTE cell.

5. The method of claim 1, wherein implementing operations of the VoWiFi to EPS-FB handover resulting in the handover of the VoWiFi call to VoLTE on the LTE cell comprises determining a signal strength of a Wi-Fi signal for the VoWiFi call and a signal strength of an LTE signal for the LTE cell.

6. The method of claim 5, wherein implementing operations of the VoWiFi to EPS-FB handover resulting in the handover of the VoWiFi call to VoLTE on the LTE cell comprises sending a second request to handover the VoWiFi call to VoLTE based at least on a comparison of the signal strength of the Wi-Fi signal for the VoWiFi call and the signal strength of the LTE signal for the LTE cell.

7. The method of claim 1, wherein implementing operations of the VoWiFi to EPS-FB handover resulting in the handover of the VoWiFi call to VoLTE on the LTE cell comprises sending a Packet Data Network (PDN) Connectivity Request with a handover request type.

8. A base station, comprising:
one or more processors; and
one or more computer-readable media storing computer-usable instructions that, when executed by the one or more processors, cause the one or more processors to:
receive a request from a user device to handover a Voice over Wi-Fi (VoWiFi) call to Voice over New Radio (VoNR) on a first cell;
determine whether the base station supports VoNR on the first cell; and
in response to a determination that the base station does not support VoNR on the first cell, send a message to the user device comprising an indicator instructing the user device to perform a VoWiFi to Evolved Packet System-Fallback (EPS-FB) handover.

9. The base station of claim 8, wherein the message to the user device comprising the indicator instructing the user device to perform the VoWiFi to EPS-FB handover comprises a Radio Resource Control (RRC) Release message with redirection to Long Term Evolution (LTE).

10. The base station of claim 9, wherein the indicator instructing the user device to perform the VoWiFi to EPS-FB handover comprises an Information Element in the RRC Release message with redirection to LTE.

11. The base station of claim 8, wherein the indicator instructing the user device to perform the VoWiFi to EPS-FB handover instructs the user device to perform an EPS-FB to a Long Term Evolution (LTE) cell and request a handover of the VoWiFi call to Voice over LTE (VoLTE) using a PDN Connectivity Request with a handover request type.

12. The base station of claim 8, wherein the computer-usable instructions that, when executed by the one or more processors, cause the one or more processors to:
receive a second request from a second user device to handover a second VoWiFi call to VoNR on a second cell;
determine whether the base station supports VoNR on the second cell; and
in response to a determination that the base station does support VoNR on the second cell, implement a VoWiFi to VoNR handover for the second VoWiFi call on the second cell.

13. A user device, comprising:
one or more processors; and
one or more computer-readable media storing computer-usable instructions that, when executed by the one or more processors, cause the one or more processors to:
while on a Voice over Wi-Fi (VoWiFi) call,
send a first request to a first base station to handover the VoWiFi call to Voice over New Radio (VoNR) on a first cell of the first base station;
receive a message including an indicator that instructs the user device to perform a VoWiFi to Evolved Packet System-Fallback (EPS-FB) handover; and
in response to the message including the indicator that instructs the user device to perform a VoWiFi to EPS-FB handover, implement a VoWiFi to EPS-FB handover using a plurality of operations.

14. The user device of claim 13, wherein the message comprises a Radio Resource Control (RRC) Release message with redirection to Long Term Evolution (LTE).

15. The user device of claim 13, wherein the plurality of operations comprises camping on a Long Term Evolution (LTE) cell.

16. The user device of claim 15, wherein the plurality of operations comprises sending a second request to handover the VoWiFi call to Voice over LTE (VoLTE) on the LTE cell.

17. The user device of claim 13, wherein the plurality of operations comprises determining a signal strength of a Wi-Fi signal for the VoWiFi call and/or determining a signal strength of an LTE signal for an LTE cell.

18. The user device of claim 17, wherein the plurality of operations comprises sending a second request to handover the VoWiFi call to Voice over LTE (VoLTE) on the LTE cell based at least on the signal strength of the Wi-Fi signal for the VoWiFi call and/or the signal strength of the LTE signal for the LTE cell.

19. The user device of claim 17, wherein the plurality of operations comprises sending a second request to handover the VoWiFi call to Voice over LTE (VoLTE) on the LTE cell based at least on a comparison of the signal strength of the Wi-Fi signal for the VoWiFi call and the signal strength of the LTE signal for the LTE cell.

20. The user device of claim 13, wherein the plurality of operations comprises sending a Packet Data Network (PDN) Connectivity Request with a handover request type.
